(19) United States
(12) Patent Application Publication
(10) Pub. No.: US 2007/0019512 A1
(43) Pub. Date: Jan. 25, 2007

(54) Television set integrated with disk unit

(75) Inventors: Masuo Ogawa, Osaka (JP); Akio Iwai, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/387,060

(22) Filed: Mar. 23, 2006

(30) Foreign Application Priority Data
Mar. 25, 2005 (JP) U2005-001534

(51) Int. Cl. G11B 21/08

(52) U.S. Cl. 369/30.85

(57) ABSTRACT

In a television set integrated with a disk unit in which the television set and the disk unit are arranged in an enclosure, the television set integrated with the disk unit is characterized in that: the television set is a flat-screen television set; the disk unit is a slot-in type DVD recorder and arranged on a rear side of the flat-screen television set; a disk insertion hole is formed in a top panel portion of the enclosure being opposed to the slot-in type DVD recorder; and an opening and closing cover for opening and closing the disk insertion hole is provided.

### BACKGROUND

1. Field

The present invention relates to a television set integrated with a disk unit in which a flat-screen television set such as a liquid crystal display panel, and a slot-in type disk unit such as a slot-in type DVD are arranged in an enclosure. More particularly, the present invention relates to a television set integrated with a disk unit, the thickness of which is reduced, the intrusion of foreign objects from a disk insertion hole of which is prevented.

2. Description of the Related Art

A conventional television set integrated with a disk unit is described in JP-A-2002-334566. Referring to FIG. 8, an example of the conventional television set integrated with a disk unit will be explained below. A television set 2 is arranged in an upper portion of an enclosure 1. A tray type disk unit 3 is arranged in a lower portion of the enclosure 1. According to an ejection signal, a tray 3a is made to proceed, and a disk D is put on the tray 3a. When the tray 3a is retracted according to a loading signal, the disk D is drawn into the disk unit 3, and information recorded on the disk D is regenerated, recorded or deleted.

According to the conventional structure described above, the tray type disk unit 3 is horizontally laid, and the depth t of the disk unit 3 is large. Accordingly, of course, the depth T of the enclosure 1 is increased, that is, the enclosure 1 becomes bulky. Therefore, it is impossible to meet the user's request of reducing the thickness of the television set.

It is possible to adopt the following structure. A flat-screen television set such as a liquid crystal display panel is used for the television set 2 and the tray type disk unit 3 is vertically laid on the rear side of the flat-screen television set. However, even when the above structure is adopted, the height h of the tray type disk unit 3 is increased by the size of the tray 3a. Accordingly, it is impossible to sufficiently meet the user's request of reducing the thickness of the television set.

In this case, the following structure can be considered as shown by virtual lines in FIG. 8. Instead of the tray type disk unit 3, a slot-in type DVD recorder (disk unit) 5 is vertically arranged. A disk insertion hole 6 is formed in a top panel portion of the enclosure 1 being opposed to the slot-in type DVD recorder 5. Through the disk insertion hole 6, a disk D is inserted into and drawn out from the slot-in type DVD recorder 5. However, according to this structure, the disk insertion hole 6 is open upward. Therefore, foreign objects such as dust easily intrude into the slot-in type DVD recorder 5 from the disk insertion hole 6, which could be a cause of trouble of the disk unit.

### SUMMARY

The present invention provides a television set integrated with a disk unit, the thickness of which is reduced, the intrusion of foreign objects from a disk insertion hole of which is prevented.

According to a first aspect, there is provided a television set including: an enclosure; a flat-screen television set that is provided in the enclosure; a slot-in type disk unit that is provided in the enclosure and arranged on a rear side of the flat-screen television set; a disk insertion hole that is formed on a top panel portion of the enclosure to face the disk unit; a cover that opens and closes the disk insertion hole; a pair of bearing portions that protrude to a rear side from the disk insertion hole on a lower face of the top panel portion; a pair of left and right arms that are integrally protruded from both end portions of the cover, the arms being pivotally supported by a support shaft that is provided at an idle end portion thereof, the support shaft being engaged into the bearing portions; an engaging piece that is integrally protruded from the bearing portion on the lower face of the top panel portion being opposed to at least one of the arms; a spring that is provided that each of end portions thereof are respectively attached to an engaging hole that is formed at an oblique lower position of the support shaft of the engaging piece, and to a movable hole that is formed in a central portion of the arm opposed to the engaging hole, wherein when the movable hole is located on a lower side of a virtual line connecting the engaging hole with the support shaft, an urging force of the spring acts downward, wherein when the movable hole is located on an upper side of the virtual line, the urging force of the spring acts upward, and wherein the cover is opened by a disk pushed up through the disk insertion hole from the disk unit resisting the spring force.

According to a second aspect, there is provided a television set including: an enclosure; a flat-screen television set that is provided in the enclosure; a slot-in type disk unit that is provided in the enclosure and arranged on a rear side of the flat-screen television set; a disk insertion hole that is formed on a top panel portion of the enclosure to face the disk unit; and a cover that opens and closes the disk insertion hole.

### BRIEF DESCRIPTION OF THE DRAWINGS

In the accompanying drawings:

FIG. 1 is a perspective view of a television set integrated with a disk unit which according to an embodiment;

FIG. 2 is a perspective view showing a primary portion in a state in which a disk insertion hole is closed in a television set integrated with a disk unit;

FIG. 3 is a perspective view showing a primary portion in a state in which a disk insertion hole is opened in a television set integrated with a disk unit;

FIG. 4 is a longitudinal sectional view showing a primary portion of a television set integrated with a disk unit;

FIG. 5 is a lower face view of a primary portion of a television set integrated with a disk unit;

FIGS. 6A-6C are lateral sectional views showing a procedure of opening and closing an opening and closing cover;

FIGS. 7A-7C are lateral sectional views showing a procedure of opening and closing a disk insertion hole; and

FIG. 8 is a perspective view showing a conventional example.

### DETAILED DESCRIPTION

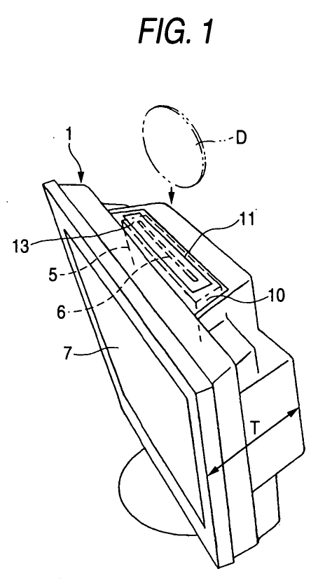

FIGS. 1-3 are views showing a television set integrated with a disk unit according to an embodiment. A flat-screen television set 7 including a liquid crystal display panel is arranged in the front portion of an enclosure 1. On the rear side of the flat-screen television set 7 arranged in the enclosure 1, a slot-in type DVD recorder (a disk unit) 5 is vertically laid. At a center of an upper face of a top panel portion 10 which is detachably attached to an upper opening portion of the enclosure 1 being opposed to the slot-in type DVD recorder 5, a rectangular recess portion 11 is formed. On a bottom face of the recess portion 11, a disk insertion hole 6 is formed. An opening and closing cover 13 to open and close the disk insertion hole 6 is fitted into the recess portion 11. In this connection, a knob portion 13a is protruded from a center of an upper face of the opening and closing cover 13.

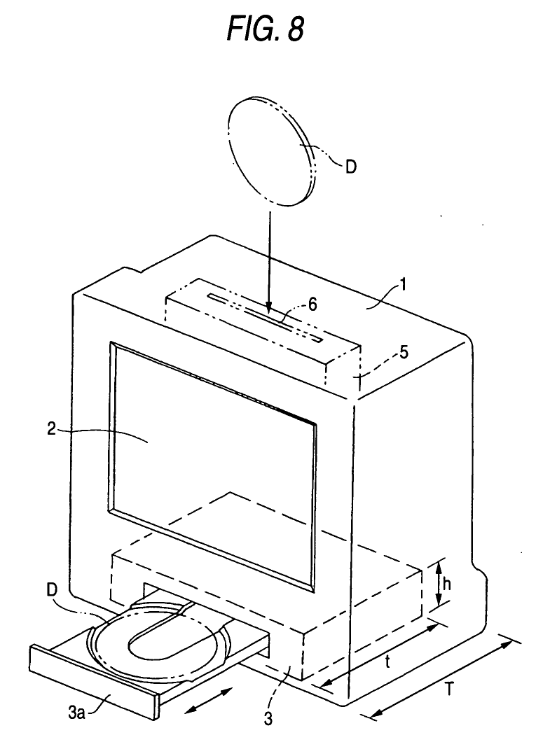

According to the above structure, the flat-screen television set 7 such as a liquid crystal display panel, and the slot-in type DVD recorder 5, the thickness of which is smaller than the tray type disk unit 3 (shown in FIG. 8) because no tray 3a is arranged, are incorporated into the enclosure 1. Therefore, the depth T of the enclosure 1 can be reduced. Accordingly, it is possible to cope with the user's request to reduce the thickness of a television set.

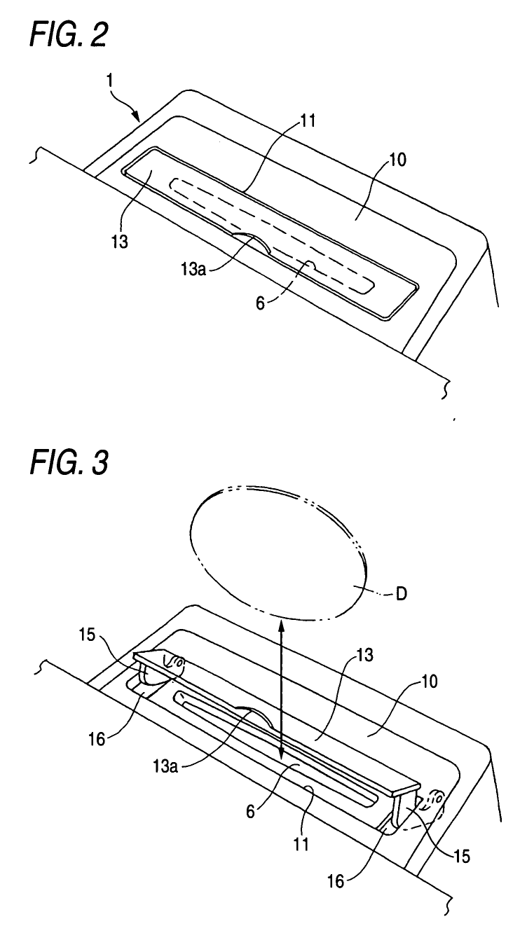

Since the disk insertion hole 6 is closed with the opening and closing cover 13 except when the disk D is inserted into or retracted from the disk unit as shown in FIG. 3, an intrusion of foreign objects such as dust into the slot-in type DVD recorder 5 can be prevented, and the occurrence of trouble caused by the intrusion of foreign objects can be prevented.

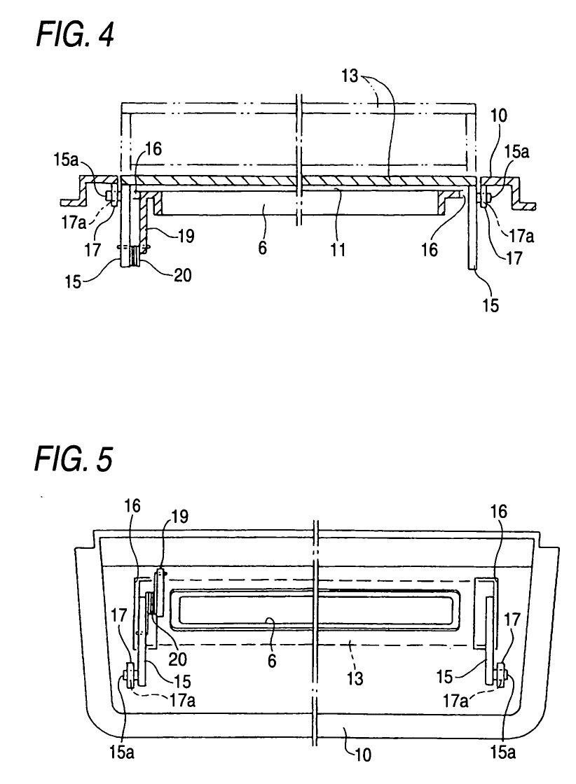

As shown in FIGS. 4-7C, a pair of U-shaped arms 15 are integrally protruded from both end portions of the lower face of the opening and closing cover 13. An idle end of each arm 15 is inserted into a through-hole 16 formed at each of both ends of the bottom face of the recess portion 11. A support shaft 15a integrally protruding from the idle end of each arm 15 is pivotally inserted into a hole 17a of a bearing portion 17 which is protruded to the rear side with respect to the disk insertion hole 6 on the lower face of the top panel portion 10. Due to the above structure, the opening and closing cover 13 is pivotally supported round both support shafts 15a being capable of opening and closing “a” and “b”.

As shown in FIGS. 4-6C, an engaging piece 19 is integrally protruded to the front side of the bearing portion 17 on the lower face of the top panel portion 10 being opposed to one of the arms 15. Both end portions of a coil spring 20 are engaged with an engaging hole 19a of the engaging piece 19, which is formed at an obliquely lower position of the support shaft 15a, and also engaged with a movable hole 15b formed at a substantially center of the arm 15 opposed to the engaging hole 19a.

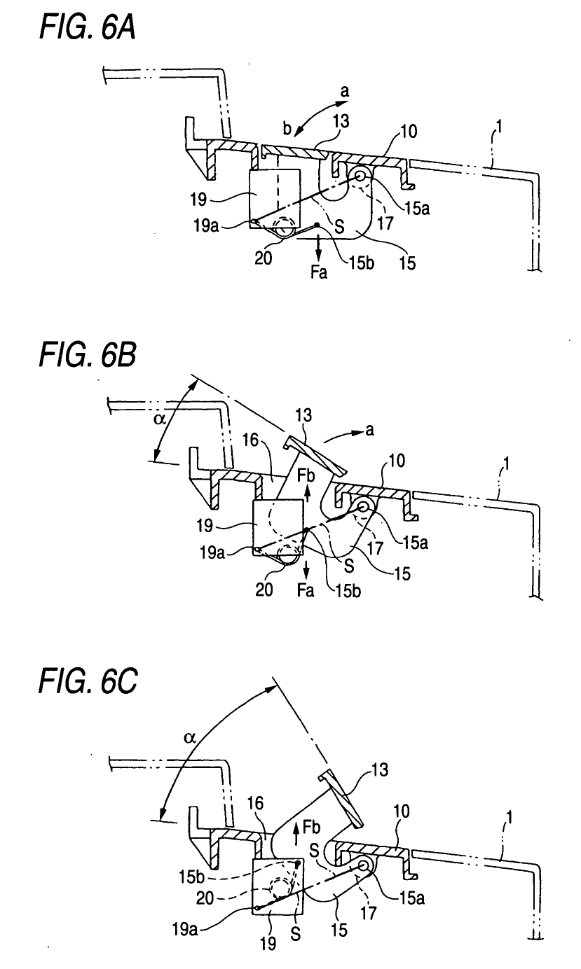

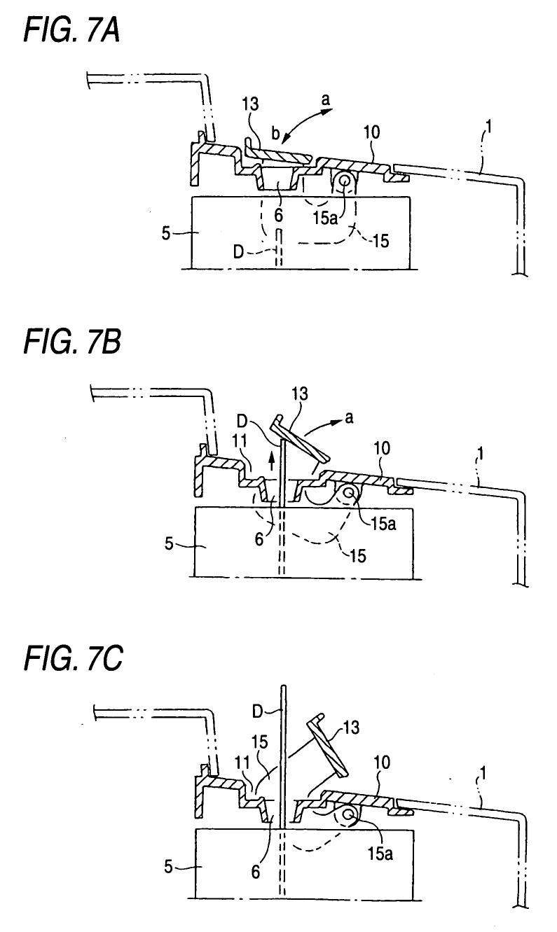

In the above structure, as shown in FIG. 6A, when the movable hole 15b is located on the lower side of the virtual line S connecting the engaging hole 19a with the support shaft 15a, a pushing force Fa of the spring 20 acts downward. Therefore, the opening and closing cover 13 is closed “b” and the disk insertion hole 6 is closed as shown in FIG. 7A.

As shown in FIG. 6B, when an opening angle a of the opening and closing cover 13 is set at about 30° and the movable hole 15b is located on the virtual line S, the pushing force Fa generated by the spring 20, which is directed downward, and the pushing force Fb, which is directed upward, are substantially balanced to each other as shown in FIG. 7B.

As shown in FIG. 6C, when the movable hole 15b is located on the upper side of the virtual line S, the pushing force Fb generated by the spring 20 acts upward. Therefore, the opening and closing cover 13 is opened “a” and the disk insertion hole 6 is opened as shown in FIG. 7C. Therefore, the opening angle α of the opening and closing cover 13 can be held at about 50°.

According to the above structure, only by one spring 20, it is possible to hold a closed posture (shown in FIG. 6A) in which the opening and closing cover 13 is closed “b” so as to close the disk insertion hole 6 and an open posture (shown in FIG. 6C) in which the opening and closing cover 13 is opened “a” so as to open the disk insertion hole 6. Accordingly, the number of parts can be decreased and the manufacturing cost can be reduced.

In the above embodiment, one spring 20 is used and provided between the arm 15 and the engaging piece 19. However, the present invention is not limited to the above specific embodiment. A pair of engaging pieces 19 may be provided being respectively opposed to the arms 15, and two arms 20 may be used and provided between the arms 15 and the engaging pieces 19. Due to this structure, the closed posture (shown in FIG. 6A) and the open posture (shown in FIG. 6C) of the opening and closing cover 13 can be more positively held.

As shown in FIG. 7A, when the disk D is pushed up from the slot-in DVD recorder 5 according to an ejection signal under the condition that the disk insertion hole 6 is closed by the opening and closing cover 13, the opening and closing cover 13 is opened “a” by the disk D, which is pushed up, resisting a spring force generated by the spring 20 as shown in FIG. 7B. When the movable hole 15b exceeds the virtual line S as shown in FIG. 6B, the opening and closing cover 13 is opened “a” by the pushing force Fb of the spring 20 all at once, and the disk insertion hole 6 is opened. Successively, as shown in FIG. 7C, when an operator holds an upper end portion of the disk D which has been pushed up through the disk insertion hole 6 and pulls it upward, the disk D can be taken out from the slot-in type DVD recorder 5.

According to the above structure, when the disk D is pushed up from the slot-in type DVD recorder 5 according to the ejection signal, the opening and closing cover 13 is automatically opened “a” by the disk D, resisting a force generated by the spring 20, and the upper end portion of the disk D is protruded upward from the disk insertion hole 6. Therefore, the operator holds the upper end portion of the disk D, which has been protruded, and can easily taken out the disk D from the slot-in type DVD recorder 5.

In the case where the disk D is inserted into the slot-in type DVD recorder 5, operation may be conducted as follows. The opening and closing cover 13 is opened “a” by the operator's finger, and the disk D is inserted into the slot-in type DVD recorder 5 through the thus opened disk insertion hole 6. Then, the opening and closing cover 13 is closed “b” by the operator's finger so as to close the disk insertion hole 6.

In the above embodiment, the slot-in type DVD recorder 5, which reproduces, records or deletes information, is taken up as an example of the slot-in type disk unit. However, it should be noted that the present invention is not limited to the above specific embodiment. For example, the present invention can be applied to a slot-in type DVD player exclusively used for reproducing information.

As described in detail with reference to the embodiment, according to the present invention, there is provided at least one of the following configurations.

(1) A television set including: an enclosure; a flat-screen television set that is provided in the enclosure; a slot-in type disk unit that is provided in the enclosure and arranged on a rear side of the flat-screen television set; a disk insertion hole that is formed on a top panel portion of the enclosure to face the disk unit; a cover that opens and closes the disk insertion hole; a pair of bearing portions that protrude to a rear side from the disk insertion hole on a lower face of the top panel portion; a pair of left and right arms that are integrally protruded from both end portions of the cover, the arms being pivotally supported by a support shaft that is provided at an idle end portion thereof, the support shaft being engaged into the bearing portions; an engaging piece that is integrally protruded from the bearing portion on the lower face of the top panel portion being opposed to at least one of the arms; a spring that is provided that each of end portions thereof are respectively attached to an engaging hole that is formed at an oblique lower position of the support shaft of the engaging piece, and to a movable hole that is formed in a central portion of the arm opposed to the engaging hole, wherein when the movable hole is located on a lower side of a virtual line connecting the engaging hole with the support shaft, an urging force of the spring acts downward, wherein when the movable hole is located on an upper side of the virtual line, the urging force of the spring acts upward, and wherein the cover is opened by a disk pushed up through the disk insertion hole from the disk unit resisting the spring force.

(2) A television set including: an enclosure; a flat-screen television set that is provided in the enclosure; a slot-in type disk unit that is provided in the enclosure and arranged on a rear side of the flat-screen television set; a disk insertion hole that is formed on a top panel portion of the enclosure to face the disk unit; and a cover that opens and closes the disk insertion hole.

(3) The television set according to (2), further including: a pair of bearing portions that protrude to a rear side from the disk insertion hole on a lower face of the top panel portion; a pair of left and right arms that are integrally protruded from both end portions of the cover, the arms being pivotally supported by a support shaft that is provided at an idle end portion thereof, the support shaft being engaged into the bearing portions; an engaging piece that is integrally protruded from the bearing portion on the lower face of the top panel portion being opposed to at least one of the arms; a spring that is provided that each of end portions thereof are respectively attached to an engaging hole that is formed at an oblique lower position of the support shaft of the engaging piece, and to a movable hole that is formed in a central portion of the arm opposed to the engaging hole, wherein the cover is configured to open the disk insertion hole by an urging force of the spring being switched to open the cover when a disk is ejected from the disk unit, so as to let an edge of the cover be in non-contact with a recording surface of the disk.

(4) The television set according to (3), wherein when the movable hole is located on a lower side of a virtual line connecting the engaging hole with the support shaft, an urging force of the spring acts downward, wherein when the movable hole is located on an upper side of the virtual line, the urging force of the spring acts upward, and wherein the cover is opened by a disk pushed up through the disk insertion hole from the disk unit resisting the spring force.

The configuration of (1) corresponds to an embodiment (shown in FIGS. 1-7C) of the invention. According to this configuration, a flat-screen television set such as a liquid crystal display panel, and a slot-in type disk unit, the thickness of which is smaller than that of the tray type disk unit because no tray is provided, are vertically incorporated into an enclosure. Therefore, the depth of the enclosure is reduced. Accordingly, this structure can sufficiently cope with a user's request of reducing the thickness of a television set.

The disk insertion hole, which is formed in the top panel portion of the enclosure being opposed to the slot-in type disk unit, is closed with the opening and closing cover at the time except when the disk is inserted into and drawn out from the disk unit. Therefore, an intrusion of foreign objects such as dust from the disk insertion hole into the slot-in type disk unit can be prevented, and the occurrence of trouble caused by the intrusion of the foreign objects can be prevented.

Further, only by one spring, it is possible to hold a closed posture in which the opening and closing cover is closed so as to close the disk insertion hole and an open posture in which the opening and closing cover is opened so as to open the disk insertion hole. Accordingly, the number of parts can be decreased and the manufacturing cost can be reduced.

Further, when the disk is pushed up from the slot-in type disk unit according to the ejection signal, the opening and closing cover is automatically opened by the disk while resisting a spring force, and an upper end portion of the disk is protruded upward from the disk insertion hole. Therefore, the disk can be easily taken out from the slot-in type disk unit by holding the protruding upper end portion.

The configuration of (2) corresponds to a basic embodiment. According to this configuration, the flat-screen television set such as a liquid crystal display panel, and the slot-in type disk unit, the thickness of which is smaller than that of the tray type disk unit because no tray is provided, are vertically incorporated into the enclosure. Therefore, the depth of the enclosure can be reduced and the user's request of reducing the thickness of the television set can be sufficiently satisfied.

The disk insertion hole, which is formed in the top panel portion of the enclosure being opposed to the slot-in type disk unit, is closed with the opening and closing cover at the time except when the disk is inserted into and drawn out from the disk unit. Therefore, an intrusion of foreign objects such as dust from the disk insertion hole into the slot-in type disk unit can be prevented, and the occurrence of trouble caused by the intrusion of the foreign objects can be prevented.

According to the configuration of (3) and (4), only by one spring, it is possible to hold a closed posture in which the opening and closing cover is closed so as to close the disk insertion hole and an open posture in which the opening and closing cover is opened so as to open the disk insertion hole. Accordingly, the number of parts can be decreased and the manufacturing cost can be reduced.

Further, when the disk is pushed up from the slot-in type disk unit according to the ejection signal, the opening and closing cover is automatically opened by the disk while resisting a spring force, and an upper end portion of the disk is protruded upward from the disk insertion hole. Therefore, the disk can be easily taken out from the slot-in type disk unit by holding the protruding upper end portion.

Although the present invention has been shown and described with reference to the embodiment, various changes and modifications will be apparent to those skilled in the art from the teachings herein. Such changes and modifications as are obvious are deemed to come within the spirit, scope and contemplation of the invention as defined in the appended claims.

What is claimed is:

1. A television set comprising:
an enclosure;
a flat-screen television set that is provided in the enclosure;
a slot-in type disk unit that is provided in the enclosure and arranged on a rear side of the flat-screen television set;
a disk insertion hole that is formed on a top panel portion of the enclosure to face the disk unit;
a cover that opens and closes the disk insertion hole;
a pair of bearing portions that protrude to a rear side from the disk insertion hole on a lower face of the top panel portion;
a pair of left and right arms that are integrally protruded from both end portions of the cover, the arms being pivotally supported by a support shaft that is provided at an idle end portion thereof, the support shaft being engaged into the bearing portions;
an engaging piece that is integrally protruded from the bearing portion on the lower face of the top panel portion being opposed to at least one of the arms;
a spring that is provided that each of end portions thereof are respectively attached to an engaging hole that is formed at an oblique lower position of the support shaft of the engaging piece, and to a movable hole that is formed in a central portion of the arm opposed to the engaging hole,
wherein when the movable hole is located on a lower side of a virtual line connecting the engaging hole with the support shaft, an urging force of the spring acts downward,
wherein when the movable hole is located on an upper side of the virtual line, the urging force of the spring acts upward, and
wherein the cover is opened by a disk pushed up through the disk insertion hole from the disk unit resisting the spring force.

2. A television set comprising:
an enclosure;
a flat-screen television set that is provided in the enclosure;
a slot-in type disk unit that is provided in the enclosure and arranged on a rear side of the flat-screen television set;
a disk insertion hole that is formed on a top panel portion of the enclosure to face the disk unit; and
a cover that opens and closes the disk insertion hole.

3. The television set according to claim 2, further comprising:
a pair of bearing portions that protrude to a rear side from the disk insertion hole on a lower face of the top panel portion;
a pair of left and right arms that are integrally protruded from both end portions of the cover, the arms being pivotally supported by a support shaft that is provided at an idle end portion thereof, the support shaft being engaged into the bearing portions;
an engaging piece that is integrally protruded from the bearing portion on the lower face of the top panel portion being opposed to at least one of the arms;
a spring that is provided that each of end portions thereof are respectively attached to an engaging hole that is formed at an oblique lower position of the support shaft of the engaging piece, and to a movable hole that is formed in a central portion of the arm opposed to the engaging hole,
wherein the cover is configured to open the disk insertion hole by an urging force of the spring being switched to open the cover when a disk is ejected from the disk unit, so as to let an edge of the cover be in non-contact with a recording surface of the disk.

4. The television set according to claim 3, wherein when the movable hole is located on a lower side of a virtual line connecting the engaging hole with the support shaft, an urging force of the spring acts downward,
wherein when the movable hole is located on an upper side of the virtual line, the urging force of the spring acts upward, and
wherein the cover is opened by a disk pushed up through the disk insertion hole from the disk unit resisting the spring force.
